(19) United States
(12) Patent Application Publication
(10) Pub. No.: US 2003/0212236 A1
(43) Pub. Date: Nov. 13, 2003

(54) Process for producing polyurethane elastomer

(76) Inventors: Luigi Pellacani, Terneuzen (NL); Holger Paschke, Muenster (DE); Michael Janssen, Steinfurt (DE); Klaus Haase, Telgte (DE)

Correspondence Address: THE DOW CHEMICAL COMPANY, INTELLECTUAL PROPERTY SECTION, 2301 N BRAZOSPORT BLVD, FREEPORT, TX, 77541-3257, US

(21) Appl. No.: 10/258,418

(22) PCT Filed: May 1, 2001
(86) PCT No.: PCT/US01/13985

(51) Int. Cl. C08G 18/08; C08G 18/20; C08G 18/00

(52) U.S. Cl. 528/54

(57) ABSTRACT

A composition is disclosed for producing an elastomer using toluene diisocyanate prepolymers. The composition is prepared by mixing (a) polyisocyanate, (b) curative component and (c) a catalyst consisting essentially of 1,8-diazabicyclo(5,4,0) undec-7-ene; wherein the polyisocyanate comprises at least 70 percent by weight of the isocyanate containing composition is a toluene diisocyanate terminated prepolymer containing less than about 2 percent by weight free toluene diisocyanate monomer and the curative component contains compounds having isocyanate-reactive groups, wherein at least 40 percent by weight of the compounds having isocyanate-reactive groups are compounds having at least one hydroxyl group.

The present invention relates to a process for producing elastomers using prepolymers based on aromatic diisocyanates and containing a low level of unreacted toluene diisocyanate (TDI).

The preparation of elastomers by reacting an aromatic isocyanate with a polyol and then chain extending with a short chain diol or aromatic diamine to form the elastomer is well known. This manufacturing process is called the prepolymer process. Depending upon the reactivity of the aromatic diisocyanate and polyol, an alternative technique can be used in the manufacture of such elastomers, namely the one shot process which includes reaction injection molding (RIM).

Reactant systems commonly used in the prepolymer process utilize TDI as the isocyanate component of the prepolymer. Commercially available TDI generally consists of an 80:20 blend of two isomers, the 2,4-TDI and the 2,6-TDI isomer. The 2,4-TDI isomer carries one isocyanate (NCO) group in the para position versus the methyl group, and one NCO group in the ortho position versus the methyl group. The NCO in the para position has greater reactivity in forming a urethane bond. When reacting commercially available TDI with a polyol to form a prepolymer, a prepolymer is produced which generally contains a majority of isocyanate groups in the ortho position versus the methyl group. These prepolymers are thus less reactive than the polyisocyanate monomers in subsequent reactions with the curative components for producing polyurethane products. Due to the low reactivity of such prepolymers, the prepolymers are generally manufactured by reaction of the polyol with a stoichiometric excess of polyisocyanate monomer, and therefore contain sufficient free polyisocyanate monomers that the reaction rates in polyurethane formation are acceptable.

Prepolymer systems from TDI and long chain polyols are described in U.S. Pat. Nos. 3,701,374, 3,963,681, 4,029,730, 4,089,822, 4,133,943 and 4,365,051. These patents describe prepolymer preparations, which contain unreacted TDI as well as high oligomer content, leading to non-uniformity in elastomer hard segments.

With more regulations regarding the use of products containing free TDI monomer, there is a drive to use products containing low levels of free TDI. Prepolymers of TDI containing a low level of free TDI monomer suffer from their poor reaction rate in a number of applications. Poor reactivity, particularly at close to room temperature, may results in a product with poor properties. Poor reactivity may also have a negative impact on productivity. Prepolymer systems having a low level of free TDI are described in the art. U.S. Pat. No. 4,556,703 discloses the preparation of polyurethane elastomers using TDI feed systems high in 2,6-isomer content for the preparation of the prepolymer. After prepolymer formation, the excess (unreacted) TDI is removed. The higher concentrations of 2,6-isomer is reported to give elastomers having lower heat buildup on flexing. U.S. Pat. Nos. 4,507,459 and 4,519,432, describe the synthesis of polyurethanes having low hysteresis, by reacting a prepolymer of a mononuclear aromatic diisocyanate and polyol with a chain extender mixture of mononuclear aromatic diamine and polyol. U.S. Pat. No. 5,115,071 describes polyurethane coatings formed from prepolymers made by reacting polyisocyanates with long chain polyols and then removing the excess unreacted polyisocyanate from the prepolymer. The resulting prepolymers are chain extended with compounds having active hydrogen atoms. None of the above systems solves the problem of the poor reaction rate between prepolymers based on TDI that have a low level of free TDI monomer and hydroxyl terminated curatives, particularly when operating at temperatures close to room temperature.

EP Patent 154180 describes the use of certain synergistic catalyst compositions for the formation of polyurethanes by reaction between hydroxyl-containing compounds and certain tertiary aliphatic diisocyanates. The reported synergistic catalyst compositions includes 1,8-diazabicyclo(5.4.0)-undec-7-ene (DBU). U.S. Pat. No. 4,150,206 describes a process for preparing foamed polyurethane with integral skin, by reacting in a mold, a polyol, a polyisocyanate, at most one part by weight of water to 100 parts by weight of polyol and catalyst, wherein the improvement comprises using an aliphatic polyisocyanate and a synergistic catalyst combination that includes DBU. DE Patent 1745418 describes a process for producing polyurethane resins from conventional polyisocyanates wherein the catalyst mixtures includes DBU. While disclosing the use of DBU, these patents make no reference to the usefulness of DBU as catalyst when reacting prepolymers based only or mainly on TDI that have a low level of free TDI monomer with curative components containing only or mainly hydroxyl-containing compounds.

To compensate for the low reactivity of prepolymers based on TDI and containing a low level of free TDI monomer, aromatic polyamines and aliphatic polyamines are typically used in the curative component. These additives aid in achieving the desired polymer properties and in achieving acceptable rates of polyurethane bond formation. U.S. Pat. No. 4,182,825 describes the use of TDI prepolymers with low content of free TDI cured with 4,4′-methylene-bis-(2-chloroaniline) (MOCA), for the manufacturing of elastomers with improved dynamic properties. Such amine curatives are relatively expensive and have some toxic properties.

It would therefore be desirable to have a catalyst system whereby the amount of the above-mentioned amines can be reduced or eliminated. It would also be advantageous to have a catalyst system whereby prepolymers based mainly on TDI that contain a low level of free TDI monomer could be effectively used in producing polyurethane products, such as elastomers, using curative components that contain mainly hydroxyl-containing compounds.

The present invention is to an elastomeric composition prepared by mixing (a) a polyisocyanate, (b) a curative component and (c) a catalyst consisting essentially of 1,8-diazabicyclo(5,4,0)undec-7-ene at an isocyanate index from 75 to 140; wherein at least 70 percent by weight of the polyisocyanate is a toluene diisocyanate terminated prepolymer containing less than about 2 percent by weight free toluene diisocyanate monomer and the curative component contains compounds having isocyanate-reactive groups, wherein at least 40 percent by weight of the compounds having isocyanate-reactive groups are compounds having at least one hydroxyl group.

Such compositions unexpectedly provide rapid curing. Despite usage of an inherently slow reacting polyisocyanate, the usage of DBU allows one to achieve complete cure in an acceptable time, even when operating at close to room temperature, and in the absence of traditional strong catalysts for the urethane bond formation, such as tin or lead catalysts. The possibility to reduce or eliminate the use of tin and lead catalysts further increases the low hazard profile associated with the present inventive formulation technology. Furthermore, the polyurethane elastomers prepared according to the teachings of the present invention are characterized by better tear-tensile-elongation properties, which reflects more complete curing due to the use of the DBU catalyst.

As discussed above, an elastomeric composition is provided by the present invention using prepolymers derived from TDI. It has been unexpectedly found that fast curing rates for urethane polymers can be achieved when using TDI prepolymers having a low free TDI monomer content by using a catalyst consisting essentially of 1,8-diazabicyclo(5,4,0)undec-7-ene (DBU).

In the present invention, the polyisocyanate composition contains at least 70 percent by weight of a TDI terminated prepolymer containing less than about 2 percent by weight free toluene diisocyanate monomer. Any of the commercially available grades of TDI, generally consisting of mixtures of 2,4- and 2,6-isomers of toluene diisocyanate, may be used for the purposes of the present invention. Crude toluene diisocyanate obtained by the phosgenation of a mixture of toluene diamine can also be used in the present invention.

Formation of prepolymers is well known in the art. Generally, the prepolymer is formed by condensation polymerization of a stoichiometric excess of polyisocyanate with a polyol. Suitable polyols include those described in U.S. Pat. No. 4,456,642, the disclosure of which is incorporated by reference. Suitable polyols are represented by polyether polyols, polyester polyols, polycarbonate polyols and polyacetal polyols. Polyamino- or polymercapto-containing compounds can also be included. Suitable polyether polyols include those prepared by polymerizing an alkylene oxide in the presence of a two to eight functional initiator compound. Examples of appropriate initiators include water, alcohols, diols, ammonia, amines, and polyfunctional hydroxylated initiators such as glycerine, sorbitol, sucrose. Examples of such polyether polyols include polyethyleneoxy polyols, polypropyleneoxy polyols, polybutyleneoxy polyols, and block copolymers of ethylene oxide and propylene oxide. Preferably, the polyether polyol is a polypropyleneoxy polyol, or a block copolymer of ethylene oxide and propylene oxide, or a mix-feed copolymer of ethylene oxide and propylene oxide. Suitable exemplary polyols include Voranol P 400, Voranol P 2000, Voranol EP 1900, Voranol CP 4755, and Voranol HF 505 available from The Dow Chemical Company. Suitable polyether polyols also include polytetramethylene glycols. Suitable polyester polyols include polyesters formed from a glycol and a saturated polyfunctional dicarboxylic acid such as prepared by reacting monoethylene glycol with adipic acid. Suitable polyester polyols with improved hydrolytic stability include polyesters formed from a glycol and a saturated polyfunctional dicarboxylic acid such as prepared by reacting hexanediol with dodecanoic acid. Also polyester of lactones can be employed for the purposes of the present invention. Polyhydroxy compounds corresponding to naturally occurring polyols (for instance, castor oil), eventually in derivatized form, may also be suitable for the purposes of the present invention. Also polyhydroxy compounds modified by vinyl polymers, which are obtained by the polymerization of styrene and acrylonitrile in the presence of polyether polyols, are suitable for the present invention. Polyhydroxy compounds in which high molecular weight polyadducts or polycondensates are contained in a finely dispersed or dissolved form, may also be employed in the present invention.

The TDI prepolymers used in the present invention contain less than 2 percent by weight of free (unreacted) TDI monomer. Preferably the prepolymers contain less than 1 percent by weight of TDI free monomer. More preferably the prepolymers contain less than 0.5 percent by weight of free TDI monomer. In a most preferred embodiment, the prepolymer contains less than 0.1 percent by weight of tree TDI monomer.

Techniques to obtain this level of free TDI monomer content are known in the art. Such methods include reacting a polyol with an excess of TDI followed by distillation to remove the excess TDI from the formed prepolymer. Another common method is to add TDI to a polyol at close to stoichiometric ratios of isocyanate groups to hydroxyl group, for example, from about 1.2 to less than 2 isocyanate groups per hydroxyl group. Further industrial methods for the manufacturing of prepolymers with low free TDI content include solvent extraction of the unreacted TDI, and selective adsorption of the unreacted TDI. Any of the industrial methods for the manufacturing of prepolymers with low free TDI content may be used for the purposes of the present invention.

The polyisocyanate composition of the present invention generally contains at least 70 percent by weight of a TDI prepolymer. In a preferred embodiment, the polyisocyanate composition contains at least 75 percent by weight of a TDI prepolymer. In a more preferred embodiment the polyisocyanate is at least 80 percent by weight of a TDI prepolymer. In a most preferred embodiment the polyisocyanate is at least 85 percent by weight of a TDI prepolymer.

In addition to the TDI prepolymers, the polyisocyanate component can contain other known aromatic and aliphatic isocyanates. Such additional polyisocyanate components can be added to modify the properties of the TDI prepolymers, for instance to reduce its viscosity. They may also be added to modify the properties of the final elastomer. Of the aromatic polyisocyanates, polymethylene polyphenylene isocyanates, the 2,2′,2,4′ and 4,4′ isomers of diphenylmethylene diisocyanate, their carbodiimide modified version, and mixtures thereof are preferred. Examples of other aromatic polyisocyanates include m- and p-phenylenediisocyanate, chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Representative examples of aliphatic polyisocyanates which can be used with the TDI prepolymers of the present invention include, 1,6-hexamethylene diisocyanate (HDI), 3-isocyanatomethyl-3,5,5-trimethylcyclohexylisocyanate (IPDI), m-tetramethylenexylene diisocyanate (TMXDI), and bis (4-isocyanateocyclohexyl)methane and bis(4-isocyanateocyclohexyl). These aliphatic isocyanates are preferably used in one of the various commercially available modified versions, characterized by low free aliphatic isocyanate monomer content, like the isocyanurate or the biuret. Hindered aliphatic isocyanates as disclosed in U.S. Pat. Nos. 4,547,478 and 4,598,103, the disclosures of which are incorporated by reference, may be also be used in the present inventions with the TDI prepolymers. Further examples of aromatic isocyanates and their derivatives are listed in U.S. Pat. No. 4,456,642, the disclosures of which is incorporated by reference.

The curative component contains isocyanate-reactive compounds, with at least 40 percent by weight of the compounds having isocyanate-reactive groups consisting of compound having at least one hydroxyl groups. In a preferred embodiment, at least 50 percent by weight of the isocyanate-reactive compounds are compounds having at least one hydroxyl group.

The hydroxyl-carrying compound used in the curative in producing the elastomers of the present invention include (a) any of the polyols as disclosed above for producing the prepolymer and (b) chain extenders or cross-linkers. Preferably, the polyol has a functionality of 2 to 8 and a hydroxyl equivalent weight between 301 and 2000. Hydroxyl-carrying compounds having lower equivalent weight will act as chain extenders or as crosslinking agents. The ratio between high molecular weight and low molecular weight hydroxyl-carrying compound used in the curative in producing the elastomers of the present invention may be adjusted depending on the desired physical-mechanical properties of the final elastomer.

Cross-linkers include alkanolamines and other compounds of 300 or lower equivalent weight having from 3 to 8, preferably from 3 to 4, active hydrogen containing groups per molecule. Examples of such compounds include glycerine and trimethyolpropane, as well as other alkylene oxide triols. Preferred are alkanolamines such as diethanolamine, triisopropanolamine, triethanolamine, diisopropanolamine, adducts of 4-8 moles of ethylene oxide and/or propylene oxide with ethylene diamine, and ammonia. The cross-linkers will create a three-dimensional polymer network. Increased stiffness and rigidity can be accomplished through use of cross-linkers.

Chain extenders include compounds having two active hydrogen-containing groups per molecule and an equivalent weight of from 30 to 300, preferably from 30 to 150. Examples of chain extenders include low-molecular polyhydric alcohols such as ethylene glycol, diethylene glycol, 1,3-propylene glycol, 1,4-butanediol, 1,6-hexamethylene glycol, diethylene glycol, triethylene glycol, and dipropylene glycol. Suitable chain extenders for the purpose of the present invention also include polyamines such as ethylene diamine, xlylenediamine, methylene-bis(o-chloroaniline, and diethyl toluene diamine. Chain extenders, when reacted with the isocyanates, will result in increased hard segment density within the matrix of the cured polyurethane polymer. Hard segments result in high-temperature properties and higher rigidity (hardness) of the polymer.

The use of such crosslinking agents or chain extenders is known in the art as disclosed in U.S. Pat. Nos. 4,863,979 and 4,963,399 and EP 549,120, the disclosures of which are incorporated herein by reference.

For producing elastomers, the isocyanate index, defined as the number or equivalents of NCO groups divided by the total number of isocyanate reactive hydrogen atom equivalents multiplied by 100, ranges from 75 to 140, and preferably from 85 to 120.

The amount of DBU catalyst used is from about 0.005 to 2 percent by weight, and preferably from 0.01 to 1.0 percent by weight based on total polyol plus isocyanate. The catalyst is commercially available as Polycat DBU from Air Products, as PC Cat DBU from Nitroil and as DBU from BASF. Additional catalysts may be used in combination with the DBU. Such catalysts include tertiary amine catalysts, such as triethylene diamine, and organic tin compounds such as tin acetate, tin octanoate, tin oleate, tin laurate and dialkyl tin decarboxylates. optionally, fillers and other conventional additives such as pigments, cross-linkers, chain extenders, defoaming agents, plasticizers, etc. may be included. Suitable plasticizers include esters of polybasic (preferably dibasic) carboxylic acids with monohydric alcohols. Polymeric plasticizers, such as polyesters of adipic acid, sebacic acid or phthalic acid can also be used. Petroleum-based hydrocarbon distillates, phenol alkylsufonates and phenyl paraffin sulfonates are other examples of plasticizers. Further suitable plasticizers are those disclosed in U.S. Pat. No. 4,456,642, the disclosures of which is incorporated herein by reference.

The Shore A hardness, as measured by DIN 53505, of the elastomers of the present invention are generally greater than 10. Preferably the Shore A hardness is greater than 15. More preferred are elastomers with a Shore A hardness of 20 or greater.

Elastomers produced according to the present invention have a wide variety of applications. Examples include shaped products subjected to severe mechanical stresses, such as tires, rollers and cone belts, wheels for industrial or for recreational goods, elastomer for footwear applications, tooling compounds.

The density of the elastomeric products are generally greater than 0.7 g/cm³, preferably greater than 0.8 g/cm³.

The elastomers of the present invention may be manufactured by casting, spraying or reaction injection molding. The process of the present invention is particularly applicable for making elastomers when the reaction temperature is below 100° C. and particularly from temperatures from 20 to 75° C.

The following examples are given to illustrate the invention and should not be interpreted as limiting in anyway. Unless stated otherwise, all parts and percentages are given by weight.

### EXAMPLES

A description of the raw materials used in the examples is as follows:

| | |
|---|---|
| Polyol A | is a dipropyleneglycol inititated polyol having an |
| | hydroxyl equivalent weight of 2,000, available from |
| | The Dow Chemical Company. |
| Polyol B | is a sorbitol initiated polyoxyethylene/ |
| | polyoxypropylene polyether polyol (approximately |
| | 20 percent EO cap) having an hydroxyl equivalent |
| | weight of about 2,000, available from The Dow |
| | Chemical Company. |
| Antifoaming agent | the antifoaming agent was obtained from Byk |
| | AG. |
| DETDA | is diethyltoluene diamine used as a chain |
| | extender. |
| Dabco 33 LV | is an amine catalyst (33 percent triethylene |
| | diamine in dipropylene glycol) available from |
| | Air Products. |
| Dabco T-12 | is dibutyl tin dilaurate obtained from Air |
| | Products. |
| DBU | is 1,8-diazabicyclo(5,4,0)undec-7-ene obtained |
| | from Air Products. |
| Isocyanate A | is a TDI prepolymer with low free TDI content |
| | (<0.5 percent) obtained from TDI and a |
| | polyether polyol: the NCO content is about 3.5 |
| | percent, available from The Dow Chemical |
| | Company under the Tradename VORASTAR B |
| | 1503. |
| Isocyanate B | is a TDI prepolymer with low free TDI content |
| | (<0.5 percent) obtained from TDI and a |
| | polyether polyol: the NCO content is about 2.0 |
| | percent. |

### Example 1

Preparation of the Elastomer: the pre-mixed formulated polyol component is added in a plastic cup to the proper amount of isocyanate component, as per desired isocyanate index, followed by intensive mixing for 30 seconds, and followed by degassing. The temperature of the components was about 40° C. The reaction profile was monitored, measuring the potlife, which is the time at which the mixed material shows such a viscosity that it is no longer easily workable.

Immediately after mixing, the mixture is poured in an open flat metal cup, thus preparing elastomer disks. No post-curing was applied. About 2 days after casting, the hardness of the disks was measured according to DIN 53505.

The following systems were evaluated according to the procedure described above.

| | A* | B* | Example 1 |
|---|---|---|---|
| FORMULATED POLYOLS | | | |
| Polyol A | 36.88 | 68.48 | 69.5 |
| DETDA | 60.00 | 28.4 | 29 |
| Antifoaming agent | 0.5 | 0.5 | 0.5 |
| Dabco 33 LV | 1.31 | 1.31 | — |
| Dabco T-12 | 1.31 | 1.31 | — |
| DBU | — | — | 1.0 |
| ISOCYANATE COMPOUNDS | | | |
| Isocyanate A | 100 | 100 | 100 |
| Isocyanate Index | 100 | 100 | 100 |
| pot life [min] | 5-6 | 5-6 | 2-4 |
| demoulding time [min] | 25 | 25 | 12 |
| ELASTOMER PROPERTIES | | | |
| (according DIN test methods) | | | |
| Shore hardness [A, 4d] | 65 | 52 | 50 |
| tensile strength | 9 | 25 | 25 |
| [N/mm²] | | | |
| elongation @ break [%] | >700 | >700 | >650 |
| tear strength [N/mm] | 23 | 10 | 21 |

*Not an example of the present invention.

These examples show that even though the catalyst level for Example 1 is much lower than the comparatives Examples A and B, the potlife is much shorter for Example 1 due to the use of the DBU. Furthermore, the use of DBU results in an improved balance of tear and tensile properties, which is an indication of a more complete curing reaction.

### Examples 2 to 5

The following systems were evaluated according to the procedure described above, studying the system over a broad index range.

| | 2 | 3 | 4 | 5 |
|---|---|---|---|---|
| FORMULATED POLYOLS | | | | |
| Polyol B | 100 | 100 | 100 | 100 |
| DBU | 0.05 | 0.05 | 0.05 | 0.08 |
| ISOCYANATE COMPOUNDS | | | | |
| Isocyanate B | 100 | 100 | 100 | 100 |
| Isocyanate Index | 80 | 90 | 100 | 100 |
| Pot life [s] | ˜240 | ˜420 | ˜600 | ˜120 |
| Gelling [s] | ˜300 | ˜480 | ˜660 | ˜1.5 |
| Shore A (24 h) | 16 | 22 | 23 | 24 |

These examples show that a small amount of DBU, even when used alone, is sufficient to achieve curing at room temperature over a broad index range.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

What is claimed is:

1. An elastomeric composition prepared by mixing (a) a polyisocyanate, (b) a curative component and (c) a catalyst consisting essentially of 1,8-diazabicyclo(5,4,0)undec-7-ene at an isocyanate index from 75 to 140; wherein at least 70 percent by weight of the polyisocyanate is a toluene diisocyanate terminated prepolymer containing less than about 2 percent by weight free toluene diisocyanate monomer and the curative component contains compounds having isocyanate-reactive groups, wherein at least 40 percent by weight of the compounds having isocyanate-reactive groups are compounds having at least one hydroxyl group.

2. The composition of claim 1 wherein the polyisocyanate contains less than 1 percent by weight of free toluene diisocyanate monomer.

3. The composition of claim 2 wherein the polyisocyanate contains 0.1 percent or less by weight of free toluene diisocyanate monomer.

4. The process of any of the preceding claims wherein the polyisocyanate comprises greater than 80 percent by weight of a toluene diisocyanate prepolymer.

5. The composition of claim 1 wherein the polyisocyanate contains up to 30 percent by weight of an aromatic diisocyanate other than toluene diisocyanate, and aliphatic polyisocyanate, prepolymers thereof or a mixture thereof.

6. The composition of claim 5 wherein the aromatic isocyanate is polymethylene polyphenylene isocyanates, 2,2′, 2,4′ or 4,4′ isomer of diphenylmethylene diisocyanate or mixtures thereof.

7. The composition of claim 1 wherein at least 50 percent by weight of the compounds having isocyanate-reactive groups are compounds having at least one hydroxyl group.

8. The composition of claim 7 wherein the polyol is a polyester or polyether polyol.

9. The composition of claim 8 wherein the polyol is a polyethyleneoxy polyol, polypropyleneoxy polyol, polybutyleneoxy polyol, or a mixture thereof.

10. The composition of any of the preceding claims wherein the catalyst comprises 0.005 to 2 percent by weight of the total amount of polyol and polyisocyanate components.

11. A process for producing an elastomer having density greater than 0.7 g/cm³, comprising mixing a composition of any of the preceding claims in a mold and recovering the produced elastomer.
